(19) United States
(12) Patent Application Publication
(10) Pub. No.: US 2025/0061083 A1
(43) Pub. Date: Feb. 20, 2025

(54) MIGRATION BRIDGE FOR CLOUD-BASED MIGRATION SOLUTIONS

(71) Applicant: Intemational Business Machines Corporation, Armonk, NY (US)

(72) Inventors: Venkateswara Rao Puvvada, Inkollu (IN); Karrthik KG, Kodaikanal (IN); Saket Kumar, Bettiah (IN); Prasad Kulkami, Pune (IN)

(73) Assignee: Intemational Business Machines Corporation, Armonk, NY (US)

(21) Appl. No.: 18/234,671

(22) Filed: Aug. 16, 2023

(51) Int. Cl. G06F 16/11; G06F 16/16

(52) U.S. Cl. CPC G06F 16/119; G06F 16/162

(57) ABSTRACT

An embodiment identifies, by a migration solution bridge engine, a stub in a filesystem, the stub being associated with a first migration solution. The embodiment modifies, by the migration solution bridge engine, the stub to conform to a second migration solution. The embodiment replicates, by the migration solution bridge engine, migrated data associated with the first migration solution, the migrated data being referred to the modified stub. The embodiment deletes, by the migration solution bridge engine, the migrated data associated with the first migration solution.

### BACKGROUND

The present invention relates generally to cloud-based environments. More particularly, the present invention relates to a method, system, and computer program for migration bridging for cloud-based migration solutions.

Migration refers to the transfer of data from one storage location to another, which may be a more distant or remote location. This practice ensures that the primary storage system is not cluttered with excessive amounts of data, particularly data that is not frequently accessed. Once data is transferred to its new location, the primary system retains a basic reference, called a “stub.” This stub may be a minimalist metadata representation of the actual data, providing necessary information to locate and access the data in its new location. Traditionally, the remote storage systems used for migration were tape-based hierarchical storage management (HSM) systems. These systems were advantageous for holding large volumes of data, measured in terabytes or petabytes, that were not being frequently accessed, known colloquially as “cold data.” In contrast, the primary, high-performance filesystems were optimized to retain only frequently accessed, or “hot,” data, freeing up space by moving cold data to hierarchical storage management systems.

However, the landscape of data storage has transformed significantly with the proliferation of affordable and easily accessible cloud storage solutions. As a result, these cloud storage solutions are gradually taking over the role that hierarchical storage management systems once dominated. Data that was traditionally stored on hierarchical storage management systems is now commonly located in these cloud platforms. The high-performance filesystems, which are the primary sources of the data, interact with these cloud solutions, migrating cold data to them and retaining only stubs to ensure smooth referencing.

### SUMMARY

An embodiment includes identifying a stub in a filesystem, the stub being associated with a first migration solution. A technical advantage of this step is the precise isolation of legacy or outdated stubs in the system. This ensures that only relevant data structures are targeted in subsequent procedures, minimizing the risk of unintentional disruptions or data losses.

The embodiment also includes modifying the stub to conform to a second migration solution. A technical advantage of this modification is the enhancement in data compatibility and adaptability. Ensuring that data structures conform to newer, more efficient, or secure migration solutions can pave the way for optimized system performance and improved scalability. This step may help that the filesystem remains agile, adaptable, and primed for future integrations.

The embodiment also includes replicating migrated data associated with the first migration solution, the migrated data being referred to the modified stub. By creating a copy of the migrated data linked to the updated stub, the system ensures a seamless transition. This helps minimize potential data loss or corruption, maintaining the integrity and reliability of the data throughout the transition phase.

The embodiment also includes deleting the migrated data associated with the first migration solution. A technical advantage here is twofold. First, it ensures that redundant and potentially outdated or less secure data structures are removed, which not only optimizes storage usage but also reduces potential security risks. Second, it streamlines the filesystem, ensuring that only the most relevant and updated data structures remain, which can contribute to enhanced system efficiency and reduced maintenance overhead.

Taken as a whole, this sequence of operations greatly enhances the robustness, efficiency, and future-readiness of a filesystem undergoing a migration process. By methodically identifying, modifying, replicating, and deleting specific components, the embodiment ensures a seamless transition from one migration solution to another.

In an embodiment, the first migration solution is a deprecated migration solution, and the second migration solution is a native migration solution. A technical advantage of transitioning from a deprecated migration solution to a native one lies in the enhancement of system compatibility and efficiency. Deprecated solutions often carry legacy protocols or methods that may not be optimized for contemporary technological environments. In contrast, native solutions are often more integrated and fine-tuned to the current system's specifications. This transition, therefore, provides better performance, reduced latency, and enhanced security.

In an embodiment, replicating the migrated data further includes duplicating a data object associated with the migrated data to conform to the second migration solution; and generating new metadata for the duplicated data object to conform to the second migration solution. The act of duplicating data objects and generating new metadata ensures data integrity during the transition. A technical advantage is twofold: firstly, it safeguards the data against loss or corruption, and secondly, by updating the metadata, it ensures that data can be accurately and efficiently accessed, referenced, or queried within the new system framework.

In an embodiment, deleting the migrated data further includes deleting the data object conforming to the first migration solution; and deleting a metadata associated with the data object conforming to the first migration solution. An advantage is the optimization of storage and computational resources. By removing outdated data objects and their associated metadata, the system reduces redundancy, freeing up space and ensuring only relevant, updated information remains. This can result in faster data retrieval times and a reduction in potential data conflicts or errors.

In an embodiment, identifying the stub further includes performing a policy scan in the filesystem to identify one or more stubs referencing data stored in a cloud storage. By utilizing a policy scan, the system ensures a thorough and comprehensive identification process. The advantage here lies in the precision with which data structures are identified, minimizing chances of oversight and ensuring that all relevant data entities are targeted for migration. This process is helpful when dealing with vast cloud storage repositories.

An embodiment includes performing the modifying, replicating, and deleting for the stubs identified responsive to performing the policy scan. An advantage of this consolidated process is the assurance of a systematic and methodical migration. Each step is contingent on the successful completion of the previous, guaranteeing a cohesive transition where data integrity is maintained throughout.

In an embodiment, the replicating further includes duplicating a data object in the cloud storage. A technical advantage of duplicating directly within cloud storage is the preservation of bandwidth and reduction in transmission latency. Direct duplication within the cloud infrastructure ensures faster processing times and reduces potential data transfer costs.

An embodiment includes deleting a reconcile database associated with the first migration solution. Deleting such a database can lead to significant savings in storage costs and a boost in performance. Reconcile databases often store transitional data or logs that, once migration is complete, are no longer necessary. Their removal ensures an optimized, clutter-free environment.

In an embodiment, the filesystem is a high-performance file system. Operating within a high-performance filesystem means faster read/write speeds, reduced latency, and enhanced scalability. An advantage is evident in scenarios where vast amounts of data are processed, accessed, or modified frequently. This kind of filesystem ensures that migration processes are conducted swiftly and efficiently, reducing system downtimes and enhancing overall productivity.

Collectively, these embodiments ensure a seamless, efficient, and robust migration process. They highlight a meticulous approach taken to ensure data integrity, system compatibility, and performance optimization. They pave the way for a migration process that is both swift and secure, ensuring minimal disruptions and setting the stage for future scalability and technological advancements.

An embodiment includes where the filesystem is a high-performance file system and includes identifying a stub using a policy scan, with the stub being associated with a deprecated migration solution. This embodiment further includes modifying the stub to conform to a native migration solution and replicating migrated data associated with the deprecated migration solution, wherein the migrated data refers to the modified stub. Additionally, this embodiment encompasses deleting the migrated data associated with the deprecated migration solution. This combination ensures a seamless migration process within high-performance file systems. The utilization of policy scans in high-performance file systems guarantees a faster and more accurate identification process. The entire embodiment results in efficient data transitions, reduced latency, and optimized storage, particularly important for systems that handle large datasets or require rapid data access. The modification of the stub to conform to a native migration solution directly enhances system compatibility and reduces potential conflicts or errors, especially in high-performance environments.

For example, an enterprise may frequently update its data management systems. They have recently transitioned from a legacy system (deprecated migration solution) to a contemporary high-performance file system with native solutions. The enterprise has vast amounts of critical data that need migration. Using the techniques described in the embodiment, the enterprise can seamlessly migrate its data, ensuring data integrity, optimized storage, and reduced latency. This directly translates to reduced downtimes, ensuring business continuity, and setting the stage for future scalability and advancements.

An embodiment includes the act of replicating migrated data which involves duplicating a data object in cloud storage and generating new metadata for the duplicated data object to conform to the second migration solution. This embodiment also encompasses deleting a reconcile database associated with the first (deprecated) migration solution. The embodiment focuses on ensuring data integrity and optimizing storage within cloud environments. Direct duplication within cloud storage preserves bandwidth, and generating new metadata enhances data retrieval and referencing capabilities. Deleting the reconcile database associated with the deprecated migration solution clears transitional data or logs, leading to storage savings and an optimized cloud environment, which can be advantageous in scenarios where cloud storage costs are a concern.

For example, a cloud service provider may aim to optimize its cloud storage for clients who transition from older storage solutions. By adopting the strategies from the second combination, the provider can ensure that migrated data retains its integrity, while outdated data structures are efficiently removed. As clients often pay for storage, the optimized environment not only results in cost savings for clients but also enhances the performance of data retrieval operations, making the provider's services more attractive and competitive.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment.

FIG. 2 depicts a block diagram of an example software integration process in accordance with an illustrative embodiment.

FIG. 3 depicts a block diagram of an example environment for cloud-based migration in accordance with an illustrative embodiment.

FIG. 4 depicts a block diagram of an example process for migration bridging for cloud-based migration solutions in accordance with an illustrative embodiment.

FIG. 5 depicts a block diagram of an example process for migration bridging for cloud-based migration solutions in accordance with an illustrative embodiment.

FIG. 6 depicts a block diagram of an example process for migration bridging for cloud-based migration solutions in accordance with an illustrative embodiment.

### DETAILED DESCRIPTION

Migration is the process of transferring data from its primary storage location to another, often more distant or remote, location. This approach ensures that the initial storage platform remains unencumbered with vast amounts of infrequently accessed data. Instead of storing the entirety of the data, the primary system may retain a basic reference known as a “stub.” This stub may be a condensed metadata representation of the actual data, acting as a guide to locate and access the full data in its relocated space. Historically, the preferred repositories for this migrated data were tape-based hierarchical storage management (HSM) systems. These storage platforms were effective for housing vast quantities of “cold data,” or information that was not being frequently accessed, often ranging into terabytes or petabytes. Meanwhile, the more agile, high-performance filesystems, which were the primary sources of the data, kept frequently accessed or “hot” data. This arrangement permitted a more efficient use of space and system resources by relocating lesser-used data to hierarchical storage management systems.

However, the data storage paradigm began to shift with the introduction and rise of affordable cloud storage solutions. These cloud-based platforms began to overshadow traditional hierarchical storage management systems, offering a more scalable and cost-effective solution for storing cold data. With this shift, high-performance filesystems began to migrate data to these cloud platforms, leaving behind only the stubs to ensure a seamless connection to the migrated data. Today, the technology market offers a myriad of solutions designed to facilitate the migration from clustered filesystems to cloud object stores. However, each solution may employ its own proprietary interaction method. Additionally, the stubs, which are remnants on the high-performance filesystems after migration, can exist in multiple formats. These formats may depend on the specific migration tool employed, which can be a hinderance when working with multiple cloud-based solutions.

Existing solutions present a challenge when organizations contemplate switching from one data migration solution to another that might be more natively integrated with their filesystem. A prevalent approach to this switchover is recalling all the migrated data back to the high-performance filesystem from their respective cloud storage systems, followed by the utilization of the new migration solution to transfer the data again. This method, however, often instigates what is referred to as “recall storms” on cloud servers, which can be a significant bottleneck, especially when the data involved runs into petabytes. The impact on performance can be considerable. Additionally, the high-performance filesystems often have a smaller storage capacity compared to their migration counterparts, necessitating intricate space management to accommodate the recalled data. The costs associated with recalling vast amounts of data, especially during these storm events, can be prohibitively expensive for end users.

Moreover, to maintain a unique identity for each migrated data or metadata, existing migration solutions frequently resort to complex naming systems. These could be intricate combinations of cluster identifications, filesystem identifications, fileset identifications, node numbers, and generation number, among others. Such naming mechanisms, while unique, can make the transition to newer migration solutions cumbersome, as newer systems might employ simpler naming conventions. Furthermore, the structure in which data is migrated varies with different solutions. While some might use a hierarchical approach of directories and objects underneath, others might rely on databases, such as SQL variants, to track files that have been deleted on the high-performance filesystem end. Another layer of complexity is added by the fact that each fileset or filesystem may be aligned with a specific cloud storage vendor, meaning the migration information may relate to a unique combination of data and metadata on one particular cloud storage platform.

The present disclosure addresses the deficiencies described above by providing a process (as well as a system, method, machine-readable medium, etc.) that serves as an integrated bridge for high-performance filesystems. This bridge may facilitate the transition between two distinct cloud data migration solutions, such as the now-deprecated transparent cloud tiering (TCT) and the more contemporary active file management (AFM). This process may facilitate a seamless transition from one older migration solution to a more filesystem native solution in a manner that is cloud vendor agnostic, eliminate the need for mass recalls of migrated data, allow for on-demand recalls when necessary, and generate stubs on the high-performance filesystem, among others. This process may help ensure that the older migration vendor can be readily discarded, and the management of stubs and migrated data can be seamlessly transferred to the new migration solution.

Illustrative embodiments provide for migration bridge for cloud-based migration solutions in cloud environments. A “migration bridge,” as used herein, may refer to a specialized system or process that aids in the transition from one data storage or processing solution to another within a cloud environment. It may act as a transitional platform or interface between varying cloud services or between different versions of a singular cloud service. For example, when moving from an older version of a cloud storage system to its newer iteration, the migration bridge may help ensure a smooth transfer of data, metadata, and other relevant configurations without significant downtime or data loss.

A “migration solution,” as used herein, may refer to a toolset implemented to shift, transfer, or move data, applications, or other digital assets from one computing environment to another. For instance, this could be the transition from on-premises infrastructure to a cloud service or between different cloud providers. In some embodiments, a migration solution may be a deprecated migration solution. For example, a deprecated migration solution may be outdated or may be no longer supported. Additionally, a migration solution may be a native migration solution. For example, a native migration solution may be inherently designed and optimized for a specific environment or platform. A “cloud-based” migration solution, as used herein, may refer to a migration method tailored for transferring digital assets within, into, or out of cloud infrastructures. It may be configured to address challenges and advantages associated with cloud environments, such as scalability, distributed architecture, and virtualization.

Illustrative embodiments provide for identifying a stub in a filesystem. A “stub,” as used herein, may refer to a placeholder or a symbolic link in a filesystem that represents data or a file which might be offloaded to another storage location, often to save space or optimize performance. For example, stubs can represent large datasets stored remotely while preserving a minimal footprint on the primary storage. In some embodiments, the stub may be associated with a first migration solution. For example, the stub may be associated with a deprecated migration solution and might require updates or modifications to be compatible with a newer system.

A “filesystem,” as used herein, may refer to the structure and logic mechanisms that manage and organize the storage, retrieval, naming, or synchronization of data files on storage mediums, such as hard drives, solid-state drives (SSDs), or cloud storage buckets. For example, filesystems can support features like journaling for data integrity, or they can be optimized for specific tasks like real-time data access. In some embodiments, the filesystem may be a high-performance file system. For example, it may be specifically designed to support rapid data access, large volumes of data, or highly concurrent access requests. Identifying a stub in a filesystem may involve a variety of techniques like recursive scanning, metadata analysis, or pattern recognition. For example, the system may might utilize a depth-first search algorithm to traverse a filesystem tree and locate all stubs, ensuring none are overlooked in the migration process.

In some embodiments, identifying a stub may involve performing a policy scan in the filesystem. A “policy scan,” as used herein, may refer to a systematic evaluation or analysis of the filesystem. This scan may aim to identify files, links, or objects that meet certain predetermined criteria or policies. By conducting this scan, the system may generate a comprehensive list of files or objects that have been fully migrated, highlighting those requiring a shift to a new migration format. For example, consider a large-scale storage system where data is frequently moved, archived, or offloaded. A policy scan could be employed to find stubs that have not been accessed for a specified duration, indicating potential candidates for migration to more cost-effective storage tiers. In some embodiments, the policy scan may be used to identify one or more stubs referencing data stored in a cloud storage. A “cloud storage,” as used herein, may refer to a service model where data is transmitted and stored on remote systems, accessible over the internet. These systems are often maintained, operated, and managed by cloud storage providers.

Illustrative embodiments provide for modifying the stub to conform to a second migration solution. Modifying the stub may involve restructuring the stub's data or metadata, redirecting its pointers, or converting its format, depending on the particular application or environment. For example, if the original stub was created using a particular path naming format, but the new migration solution utilizes a more streamlined path naming convention, the modification would convert the path name, ensuring compatibility. In some embodiments, for example, the stub may be modified to conform to a native migration solution.

Illustrative embodiments provide for replicating migrated data associated with the first migration solution. “Migrated data,” as used herein, may refer to data sets that have been transferred from their original location to another, be it a different server, storage tier, or a distinct cloud provider. For example, if a business that initially archived old records to a local data center decides to leverage a cloud storage, the data from the local center, when transferred to the cloud, may become the migrated data. Replicating migrated data may involve creating identical copies of the data in a different path or location.

In some embodiments, the migrated data may be referred to the modified stub. This process may involve associating or linking the migrated data to the previously modified stub. For example, once the stub is modified for the new migration solution, it may need to accurately represent or point to the correct set of data. This process ensures that the modified stub correctly references the replicated data, maintaining data coherence and accessibility.

In some embodiments, replicating the migrated data may involve duplicating a data object associated with the migrated data to conform to the second migration solution. A “data object,” as used herein, may refer to a structured collection of data that is stored, accessed, or manipulated as a singular unit, often encapsulating both the data itself and methods or functions associated with the data. In some embodiments, a data object may reside in a cloud storage. For example, for a database where every employee record embodies a data object, a data object may contain details like name, role, and hire date, as well as methods to modify or retrieve this information. This data object could reside within a cloud storage infrastructure, being stored off-premises, leveraging cloud services.

Duplicating a data object may involve ensuring that all its attributes, behaviors, and associations are retained. For example, a duplicated data object may retain all the properties of the original, from content to creation date, but may exist as a distinct entity, allowing for independent manipulations without affecting the original. Conforming the data object to the second migration solution may involve transforming its structure, modifying its attributes, or ensuring its format is compatible with the new migration solution's specifications.

Additionally, in some embodiments, replicating the migrated data may involve generating new metadata for the duplicated data object to conform to the second migration solution. “Metadata,” as used herein, may refer to a set of data that describes and gives information about other data. For example, metadata may include information related to contents, origin, destination, creation date, amongst other data. Generating new metadata may involve collecting, organizing, and structuring relevant information about the data object, ensuring a comprehensive descriptor is formed. For example, when copying a digital file, new metadata might capture details like the date of duplication, source of the original file, and intended use of the duplicate. Conforming the metadata to the second migration solution may involve ensuring its format, content, and structure are coherent with the requirements and standards of the target system. For example, if the new system employs a specific labeling or tagging convention, the metadata could be restructured to adopt this convention, ensuring seamless integration.

Illustrative embodiments provide for deleting the migrated data associated with the first migration solution. Deleting the migrated data may involve removing data objects, clearing associated memory spaces, or invalidating links or references to the data. For example, this process may involve removing redundant or obsolete files, ensuring optimized storage utilization and system performance. In some embodiments, deleting the migrated data may involve deleting the data object conforming to the first migration solution. This deletion could focus on the data object which was shaped by the first migration solution, which may comprise a targeted removal of specific data structures, naming conventions, or units, among others. For example, in a cloud storage setting, this could entail sending delete requests to remove specific objects, ensuring they are purged from the storage buckets and any associated caches. Additionally, in some embodiments, deleting the migrated data may involve deleting a metadata associated with the data object conforming to the first migration solution. Deleting metadata may involve invalidating its references, clearing associated storage, or purging its entries from databases. For example, in a document management system, this process might involve removing the document properties or descriptors, ensuring no trace remains of the previous metadata entries.

Illustrative embodiments provide for deleting a reconcile database associated with the first migration solution. A “reconcile database,” as used herein, may refer to a database system used for keeping track of changes, discrepancies, or inconsistencies between two sets of data. It may serve as a mechanism to ensure data integrity and consistency when migrating or syncing data between different systems or platforms. Deleting a reconcile database may include invalidating its references, clearing out the associated memory allocations, purging its records from storage systems, or ensuring that all backup copies or cached versions are also systematically removed.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

The process software for migration bridging for cloud-based migration solutions is integrated into a client, server and network environment, by providing for the process software to coexist with applications, operating systems and network operating systems software and then installing the process software on the clients and servers in the environment where the process software will function.

The integration process identifies any software on the clients and servers, including the network operating system where the process software will be deployed, that are required by the process software or that work in conjunction with the process software. This includes software in the network operating system that enhances a basic operating system by adding networking features. The software applications and version numbers will be identified and compared to the list of software applications and version numbers that have been tested to work with the process software. Those software applications that are missing or that do not match the correct version will be updated with those having the correct version numbers. Program instructions that pass parameters from the process software to the software applications will be checked to ensure the parameter lists match the parameter lists required by the process software. Conversely, parameters passed by the software applications to the process software will be checked to ensure the parameters match the parameters required by the process software. The client and server operating systems, including the network operating systems, will be identified and compared to the list of operating systems, version numbers and network software that have been tested to work with the process software. Those operating systems, version numbers and network software that do not match the list of tested operating systems and version numbers will be updated on the clients and servers in order to reach the required level.

After ensuring that the software, where the process software is to be deployed, is at the correct version level that has been tested to work with the process software, the integration is completed by installing the process software on the clients and servers.

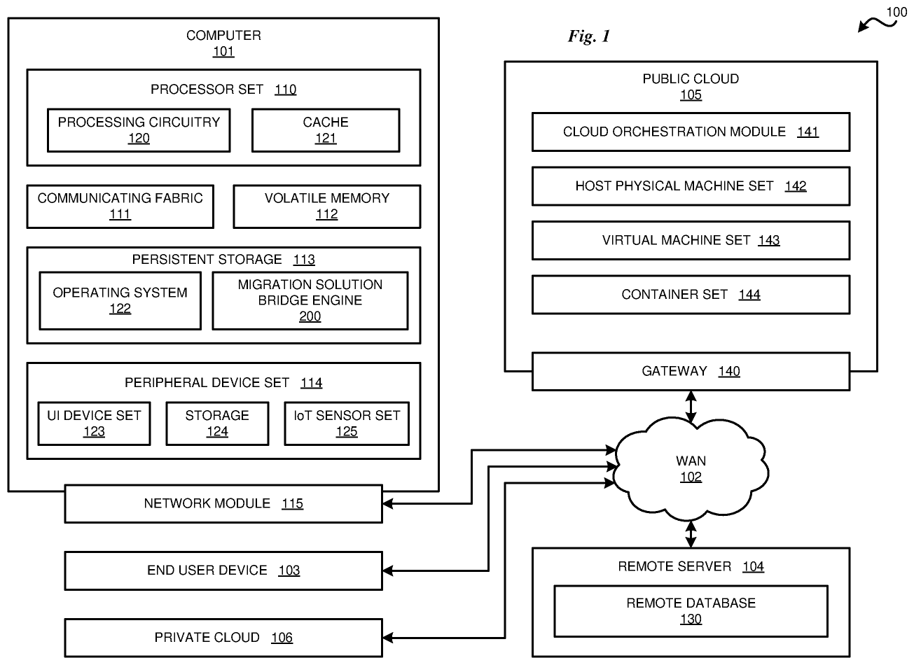

With reference to FIG. 1, this figure depicts a block diagram of a computing environment 100. Computing environment 100 contains an example of an environment for the execution of at least some of the computer code involved in performing the inventive methods, such as migration solution bridge engine 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

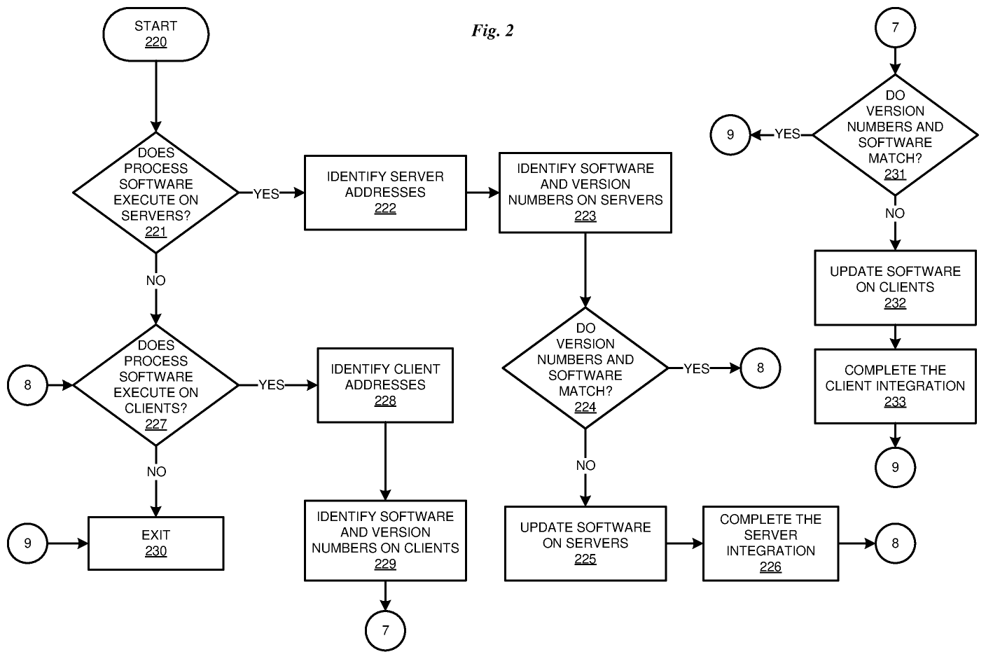

With reference to FIG. 2, this figure depicts a block diagram of an example software integration process, which various illustrative embodiments may implement. Step 220 begins the integration of the process software. An initial step is to determine if there are any process software programs that will execute on a server or servers (221). If this is not the case, then integration proceeds to 227. If this is the case, then the server addresses are identified (222). The servers are checked to see if they contain software that includes the operating system (OS), applications, and network operating systems (NOS), together with their version numbers that have been tested with the process software (223). The servers are also checked to determine if there is any missing software that is required by the process software (223).

A determination is made if the version numbers match the version numbers of OS, applications, and NOS that have been tested with the process software (224). If all of the versions match and there is no missing required software, the integration continues (227).

If one or more of the version numbers do not match, then the unmatched versions are updated on the server or servers with the correct versions (225). Additionally, if there is missing required software, then it is updated on the server or servers (225). The server integration is completed by installing the process software (226).

Step 227 (which follows 221, 224 or 226) determines if there are any programs of the process software that will execute on the clients. If no process software programs execute on the clients, the integration proceeds to 230 and exits. If this not the case, then the client addresses are identified (228).

The clients are checked to see if they contain software that includes the operating system (OS), applications, and network operating systems (NOS), together with their version numbers that have been tested with the process software (229). The clients are also checked to determine if there is any missing software that is required by the process software (229).

A determination is made if the version numbers match the version numbers of OS, applications, and NOS that have been tested with the process software (231). If all of the versions match and there is no missing required software, then the integration proceeds to 230 and exits.

If one or more of the version numbers do not match, then the unmatched versions are updated on the clients with the correct versions 232. In addition, if there is missing required software, then it is updated on the clients 232. The client integration is completed by installing the process software on the clients 233. The integration proceeds to 230 and exits.

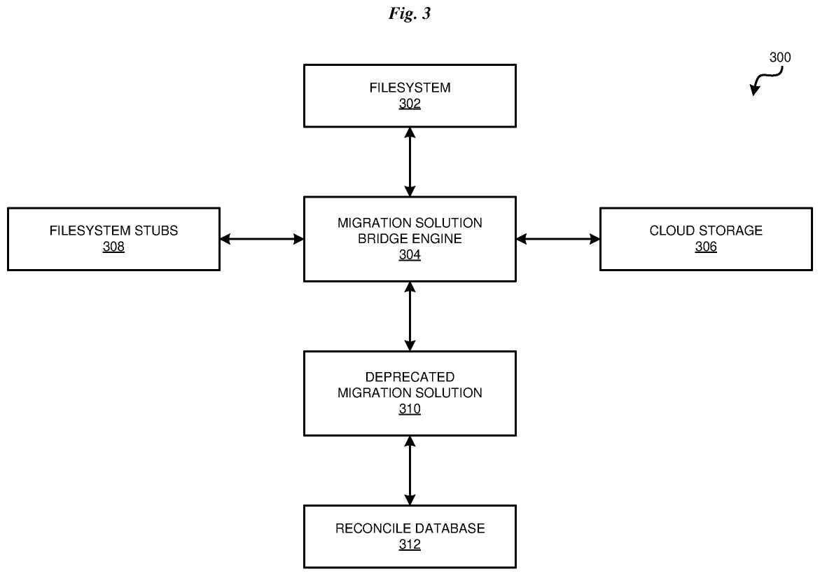

With reference to FIG. 3, this figure depicts a block diagram of an example environment for cloud-based migration 300. In the depicted example, environment 300 may comprise filesystem 302, migration solution bridge engine 304, cloud storage 306, new migration solution 308, deprecated migration solution 310, and reconcile database 312. It is to be understood that the environment 300 may comprise additional or fewer components than those shown in the illustrative embodiment.

Filesystem 302 may represent the primary storage architecture where the data resides. This filesystem may interface with both the old and new migration solutions, ensuring data consistency and integrity. It may be configured to store, manage, and retrieve data efficiently, ensuring optimal performance and data accessibility. For example, the filesystem might consist of a high-performance configuration tailored to serve frequently accessed, or “hot,” data while referencing migrated data stored in a cloud storage. A filesystem may be broken down into one or more filesets, which may represent individual collections or groupings of files with shared properties or characteristics. Each fileset might be associated with specific data types, usage patterns, or user groups, allowing for optimized storage strategies and access controls. In scenarios where data migration is imperative, filesets can be moved or replicated between different storage mediums or platforms.

In some embodiments, filesystem may store one or more stubs for referencing the migrated data. A filesystem stub may represent placeholders or references in the primary storage that point to migrated data in the cloud storage. It may be configured to store concise metadata representations, rather than the actual data, guiding any requests to the full data's location in the cloud. For example, when a user accesses a file that has been migrated, the stub may redirect the request to the data's location in the cloud.

Migration solution bridge engine 304 may represent a specialized component configured to facilitate a seamless transition between the deprecated migration solution and a newer, more efficient one. It may be configured to undertake tasks like the conversion of mangled name formats and the reconstruction of stub references on the filesystem. For example, an operation might involve the bridge engine scanning all stubs, understanding their relation to the data in cloud storage, and then transitioning that data to its own naming and referencing format.

Cloud storage 306 may represent a cloud destination for migrated data, which may offer more scalable, affordable, or efficient storage. It may be configured to house both “hot” and “cold” data based on the frequency of access and the cost-efficiency desired. For example, data that has not been accessed for prolonged periods might be moved to colder tiers within the cloud storage, optimizing cost and storage efficiency.

Migration solution(s) 308 and 310 may represent various tools or software platforms designed to facilitate the transfer of data between primary storage systems and cloud-based storage destinations. They may be configured to optimize the migration process, ensuring data consistency, reliability, and minimizing potential downtime or data loss. For example, these solutions could use algorithms to decide when and which data to move, based on access frequency, storage costs, or other configurable parameters. In some embodiments, migration solution(s) may include one or more deprecated migration solutions and/or new migration solutions. That is, the environment may support both older and more contemporary migration methods, allowing for a transitional phase or compatibility with various infrastructure setups.

Deprecated migration solution 310 may represent an older data migration mechanism, which may have been initially used to move data from the filesystem to the cloud storage. It may be configured to employ specific methods and naming conventions for data migration, such as the use of mangled names. For example, this older solution might rely on a hierarchical approach of directories and objects, which could differ from newer methods.

New migration solution 308 may represent an advancement in data migration technology, offering enhanced features, better integration capabilities, or more efficient data transfer mechanisms than deprecated migration solutions. It may be configured to seamlessly interact with both the original data storage systems and cloud platforms, ensuring a smoother and faster migration experience. For example, the newer solution might employ machine learning to predict user access patterns, thereby automating data tiering between “hot” and “cold” storage tiers more efficiently.

Reconcile database 312 may represent a registry or log that keeps track of migrated data and ensures there are no discrepancies or mismatches. It may be configured to provide real-time updates, making it an essential tool in the deprecated migration solution's operation. For example, this might involve ensuring that file versions match between the filesystem and cloud storage or flagging any anomalies.

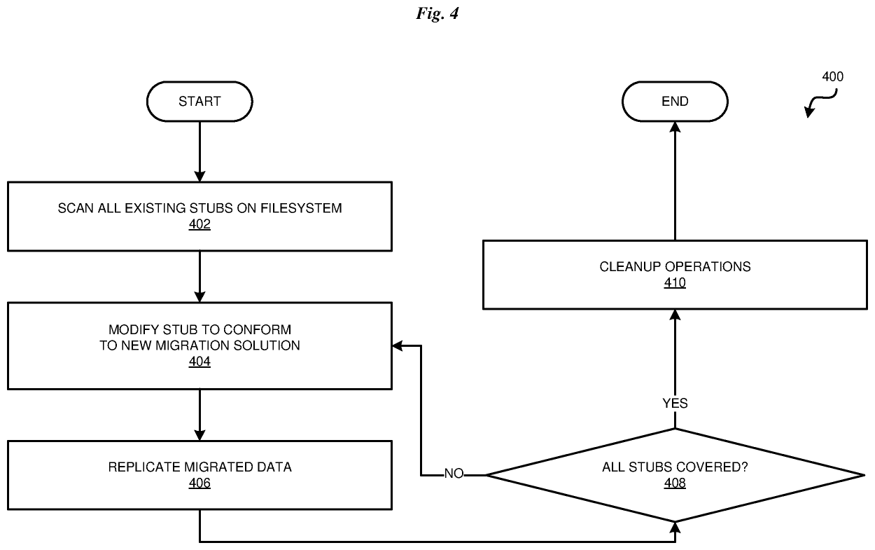

With reference to FIG. 4, this figure depicts a block diagram of an example process for migration bridging for cloud-based migration solutions in accordance with an illustrative embodiment 400. The example block diagram of FIG. 4 may be implemented using migration solution bridge engine 200 of FIG. 1.

In the depicted example, at block 402, the process may scan all existing stubs on a filesystem. This process may involve querying the filesystem with specific search parameters, potentially using recursive traversal techniques to ensure no stub is skipped. This search may leverage inode tables or master file table (MFT) entries to quickly locate these stubs. This scanning process may identify each stub and allow the system to understand the hierarchical structure of migrated data, facilitating easier mapping to cloud storage counterparts. For example, this process may involve running a policy scan to identify all stubs that have a reference back to a cloud storage for migrated data or metadata. This step may help ensure the identification of all files or objects that have been entirely migrated and need transition to the new migration solution's format.

At block 404, the process may modify a stub to conform to the new migration solution. This process may involve interpreting the existing stub's metadata, including any links or references to cloud-based storage, and then adjusting these metadata components to align with the expectations and requirements of the new migration solution. Such modifications might involve restructuring the stub's internal pointers, adding or removing specific metadata fields, or translating any data format aspects that differ between the old and new migration systems, among other operations. For example, if the old migration system used a specific naming convention or encoding method for its cloud storage references, the new system might require these references to be converted into a simpler, directory-like structure. This process may help ensure that each stub remains functional and accurately points to its corresponding data in cloud storage.

At block 406, the process may replicate the migrated data. In embodiments where the data is migrated to a cloud storage, for example, the process may replicate the cloud data object to match the naming or structural convention of the new migration solution. This step may involve sending a copy request to the cloud storage vendor, thereby generating a copy of the data without requiring it to be recalled to the high-performance filesystem. Additionally, once replicated successfully, any old or obsolete data objects, using the previous naming convention, may be flagged for deletion or archived for backup purposes. For example, the .data object of the previous migration solution might be replicated with a straightforward filename structure in line with the new migration solution's standards. Afterward, the .data object associated with the old migration system can be removed, minimizing clutter and redundancy within the cloud storage.

At block 408, the process may determine whether all the stubs have been processed. This process may involve a dynamic monitoring mechanism, such as by using a hashmap or a binary tree, to quickly ascertain which stubs have been addressed and which await processing. This approach may help minimal time complexity, thus speeding up the overall process, such as when dealing with massive volumes of stubs. For example, this process may involve checking a tracking mechanism or a counter against the total number of stubs identified during the initial scan. If not all stubs have been processed, the process may return to blocks 404 and 406.

At block 410, if all the stubs have been processed, the process may proceed to perform one or more cleanup operations. This process may involve deleting redundant or outdated stubs, verifying that all data objects in cloud storage match the new system's conventions, or updating any internal system logs or tracking mechanisms to reflect the completed migration, among other operations. For example, if the process encounters a reconciliation engine associated with the deprecated migration solution, the process may delete the reconciliation engine after processing all stubs. It might also compile a report detailing any discrepancies found, any data that could not be migrated, flagging any potential issues for manual review or intervention, or any other suitable operation.

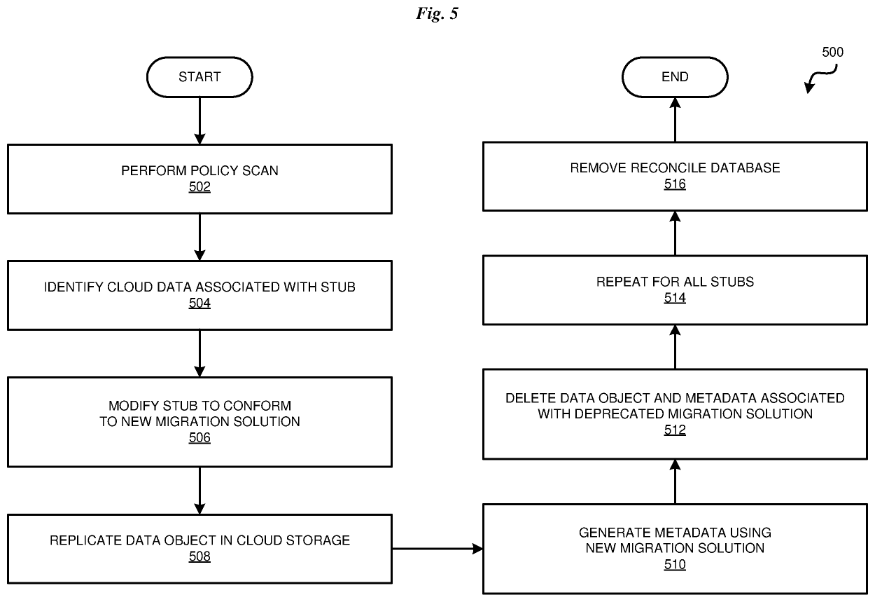

With reference to FIG. 5, this figure depicts a block diagram of an example process for migration bridging for cloud-based migration solutions in accordance with an illustrative embodiment 500. The example block diagram of FIG. 5 may be implemented using migration solution bridge engine 200 of FIG. 1.

In the depicted example, at block 502, the process may perform a policy scan. This process may involve scanning the filesystem to identify and categorize all stubs that reference cloud-stored data or metadata. This scan might utilize an algorithm that specifically targets stubs, identifying their respective cloud storage locations and the characteristics of the data they point to. For example, the process may query all stubs that contain references pointing back to a cloud storage where the migrated data or metadata is stored. As a result of this scan, the process may compile a list of files or objects that have been fully migrated and therefore, necessitate conversion into the new migration solution's format. The policy scan may systematically go through each data point to identify and categorize those that have been moved to the cloud, ensuring that none are left behind during the transition.

At block 504, the process may identify cloud data associated with a stub. This process may involve querying the cloud storage system using the references contained within each stub to pinpoint the exact location and state of the associated data. This step may help ensure that the data's integrity, state, and location are well-understood before any migration actions take place. For example, a stub might contain a path pointing towards a specific object in cloud storage. The process may query this path to retrieve key information about the data, such as its size, last modified timestamp, or any associated metadata tags.

At block 506, the process may modify the stub to conform to the new migration solution. This process may involve updating the internal structure of the stub, including any pointers or references, to align with the expectations of the new migration system. Furthermore, any metadata formats, naming conventions, or encoding methods that differ between the old and new systems will be translated and adjusted.

At block 508, the process may replicate the data object in the cloud storage using the new migration solution's naming convention. This process may involve creating a copy of the data object, naming and structuring it according to the new solution's guidelines, and placing it within the appropriate directory or bucket. For example, an object named “Data01.OLD” under the previous system might be replicated and renamed to “NewData01.NEWSYS” to conform to the naming conventions of the new system.

At block 510, the process may generate metadata for the stub using the new migration solution. This process may involve deriving information from the newly replicated data object, and then formatting and attaching this metadata to the stub in a manner compatible with the new migration system. For example, after replicating the data object, the system might extract its size, creation date, and associated tags, then embed this information into the stub using the format of the new migration solution.

At block 512, the process may delete the data object and the metadata associated with the deprecated migration solution. This process may involve marking the outdated data objects and their associated metadata for deletion, and subsequently removing them to free up storage space and reduce clutter. For example, after successful replication and metadata generation, the old “Data01.OLD” object and its metadata may be deleted from the cloud storage.

At block 514, the process may repeat the above blocks for all stubs. This process may involve iterating over each identified stub from the policy scan, and systematically applying the aforementioned steps to ensure each stub and its associated data are migrated effectively. For example, the system might use a loop or recursive function to process each stub in sequence, ensuring no data is missed.

At block 516, the process may remove a reconcile database associated with the deprecated migration solution. This process may involve identifying, archiving, and eventually deleting any databases or tracking systems used by the old migration solution to monitor or manage stubs and cloud data. For example, if the old system used a structured query language (SQL) database to track migrated data, this database might be archived for backup purposes before being deleted, ensuring a clean slate for the new migration solution.

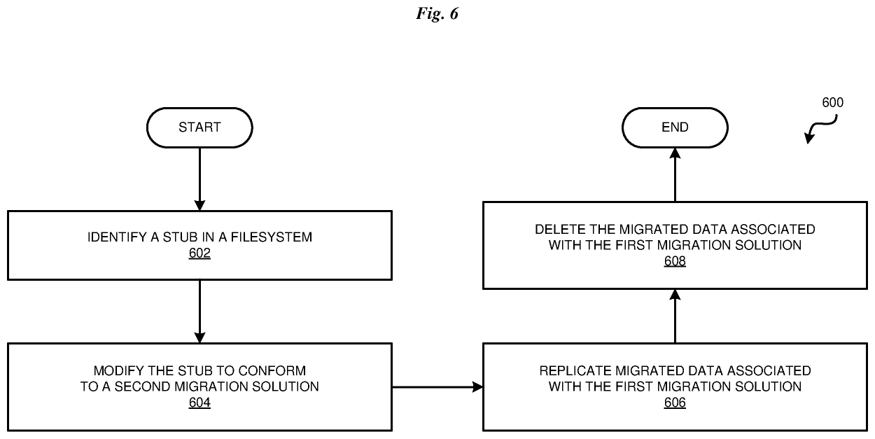

With reference to FIG. 6, this figure depicts a block diagram of an example process for migration bridging for cloud-based migration solutions in accordance with an illustrative embodiment 600. The example block diagram of FIG. 6 may be implemented using migration solution bridge engine 200 of FIG. 1.

In the illustrative embodiment, at block 602, the process may identify a stub in a filesystem, the stub being associated with a first migration solution. At block 604, the process may modify the stub to conform to a second migration solution. At block 606, the process may replicate migrated data associated with the first migration solution, the migrated data being referred to the modified stub. At block 608, the process may delete the migrated data associated with the first migration solution.

The following definitions and abbreviations are to be used for the interpretation of the claims and the specification. As used herein, the terms “comprises.” “comprising,” “includes,” “including.” “has.” “having.” “contains” or “containing.” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment.” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about.” “substantially,” “approximately,” and variations thereof, are intended to include the degree of error associated with measurement of the particular quantity based upon the equipment available at the time of filing the application. For example, “about” can include a range of +8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (Saas) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
identifying, by a migration solution bridge engine, a stub in a filesystem, the stub being associated with a first migration solution;
modifying, by the migration solution bridge engine, the stub to conform to a second migration solution;
replicating, by the migration solution bridge engine, migrated data associated with the first migration solution, the migrated data being referred to the modified stub; and
deleting, by the migration solution bridge engine, the migrated data associated with the first migration solution.

2. The method of claim 1, wherein the first migration solution is a deprecated migration solution, and the second migration solution is a native migration solution.

3. The method of claim 1, wherein replicating the migrated data further comprises:
duplicating a data object associated with the migrated data to conform to the second migration solution; and
generating new metadata for the duplicated data object to conform to the second migration solution.

4. The method of claim 3, wherein deleting the migrated data further comprises:
deleting the data object conforming to the first migration solution; and
deleting a metadata associated with the data object conforming to the first migration solution.

5. The method of claim 1, wherein identifying the stub further comprises:
performing a policy scan in the filesystem to identify one or more stubs referencing data stored in a cloud storage.

6. The method of claim 5, further comprising:
performing the modifying, replicating, and deleting for the stubs identified responsive to performing the policy scan.

7. The method of claim 6, wherein the replicating further comprises:
duplicating a data object in the cloud storage.

8. The method of claim 1, further comprising:
deleting a reconcile database associated with the first migration solution.

9. The method of claim 1, wherein the filesystem is a high-performance file system.

10. A computer program product comprising one or more computer readable storage media, and program instructions collectively stored on the one or more computer readable storage media, the program instructions executable by a processor to cause the processor to perform operations comprising:
identifying, by a migration solution bridge engine, a stub in a filesystem, the stub being associated with a first migration solution;
modifying, by the migration solution bridge engine, the stub to conform to a second migration solution;
replicating, by the migration solution bridge engine, migrated data associated with the first migration solution, the migrated data being referred to the modified stub; and
deleting, by the migration solution bridge engine, the migrated data associated with the first migration solution.

11. The computer program product of claim 10, wherein the first migration solution is a deprecated migration solution, and the second migration solution is a native migration solution.

12. The computer program product of claim 10,
wherein replicating the migrated data further comprises:
duplicating a data object associated with the migrated data to conform to the second migration solution; and
generating new metadata for the duplicated data object to conform to the second migration solution; and
wherein deleting the migrated data further comprises:
deleting the data object conforming to the first migration solution; and
deleting a metadata associated with the data object conforming to the first migration solution.

13. The computer program product of claim 10, wherein identifying the stub further comprises:
performing a policy scan in the filesystem to identify one or more stubs referencing data stored in a cloud storage.

14. The computer program product of claim 13, wherein the replicating further comprises:
duplicating a data object in the cloud storage.

15. The computer program product of claim 10, further comprising:
deleting a reconcile database associated with the first migration solution.

16. A computer system comprising a processor and one or more computer readable storage media, and program instructions collectively stored on the one or more computer readable storage media, the program instructions executable by the processor to cause the processor to perform operations comprising:
identifying, by a migration solution bridge engine, a stub in a filesystem, the stub being associated with a first migration solution;
modifying, by the migration solution bridge engine, the stub to conform to a second migration solution;
replicating, by the migration solution bridge engine, migrated data associated with the first migration solution, the migrated data being referred to the modified stub; and
deleting, by the migration solution bridge engine, the migrated data associated with the first migration solution.

17. The computer system of claim 16, wherein the first migration solution is a deprecated migration solution, and the second migration solution is a native migration solution.

18. The computer system of claim 16,
wherein replicating the migrated data further comprises:
duplicating a data object associated with the migrated data to conform to the second migration solution; and
generating new metadata for the duplicated data object to conform to the second migration solution; and
wherein deleting the migrated data further comprises:
deleting the data object conforming to the first migration solution; and
deleting a metadata associated with the data object conforming to the first migration solution.

19. The computer system of claim 16, wherein identifying the stub further comprises:
performing a policy scan in the filesystem to identify one or more stubs referencing data stored in a cloud storage.

20. The computer system of claim 16, further comprising:
deleting a reconcile database associated with the first migration solution.
